(19) United States
(12) Patent Application Publication
(10) Pub. No.: US 2002/0036266 A1
(43) Pub. Date: Mar. 28, 2002

(54) Infrared optical gas analyzer

(76) Inventors: Peter Dreyer, Pansdorf (DE); Gunter Steinert, Bad Oldesloe (DE)

Correspondence Address: McGLEW AND TUTTLE, P.C., SCARBOROUGH STATION, SCARBOROUGH, NY, 10510-0827, US

(21) Appl. No.: 09/878,259

(22) Filed: Jun. 11, 2001

(30) Foreign Application Priority Data
Sep. 27, 2000 (DE) DE 100 47728.3-42

(51) Int. Cl. G01N 21/61

(52) U.S. Cl. 250/345; 250/343

(57) ABSTRACT

An infrared optical gas analyzer is provided with at least one infrared optical radiation source (6, 7), two multispectral detectors (1, 2) and a cuvette (12) containing the gas mixture to be measured. A process for determining gas concentrations with the infrared optical gas analyzer is also provided. The gas analyzer makes possible the simultaneous measurement and identification of a plurality of gases in a gas mixture with a compact design not prone to interference. The radiation emitted by an infrared optical radiation source (6) covers a first wavelength range [λ₁, λ_{1′}] and the radiation emitted by an infrared optical radiation source (7) covers a second wavelength range [λ₂, λ_{2′}] which is selected such that it is different from the first wavelength range. The paths of rays pass through the interior of the cuvette (12) and reach the multispectral detectors (1) and (2). These pass on the signals received to an evaluating and control unit (13), which calculates the gas concentrations taking into account cross sensitivities during the measurement by the multispectral detectors (1) and (2).

### BACKGROUND OF THE INVENTION

An infrared optical gas analyzer of this type has been known from DE 197 160 61 C1.

An infrared optical gas-measuring system with two infrared radiation sources and at least one multispectral sensor, which is suitable for the determination of the concentrations of various components of a gas flow, is described there. The two infrared radiation sources emit radiation in different spectral ranges with two different cycle frequencies. The emitted rays are first passed over a radiation coupler, after which they pass through the gas flow to be measured perpendicularly to the direction of flow and finally reach the multispectral sensor for the intensity measurement.

The fact that a simultaneous measurement of carbon dioxide, laughing gas, another foreign gas, e.g., methane, and the identification and measurement of a gaseous anesthetic mixture consisting of two components is not possible with the compact design described there proved to be a drawback of the infrared optical gas-measuring system.

The simultaneous measurement and identification of different gases in a gas mixture with infrared optical methods is possible with filter wheels, which are equipped with different filters, which let through the infrared radiation in a wavelength range that belongs to the absorption range of a gas to be measured in the gas mixture.

However, the design effort is high in the case of gas-measuring devices which operate with filter wheels. The mechanical components necessary for this require comparatively much space and are prone to wear.

### SUMMARY AND OBJECTS OF THE INVENTION

The primary object of the present invention is to provide an infrared optical gas analyzer which, having a compact design not prone to interference, makes possible the simultaneous measurement and identification of a plurality of gases in a gas mixture.

According to the invention, an infrared optical gas analyzer is provided with a first infrared optical radiation source, with a first multispectral detector, with a second multispectral detector and with a cuvette containing the gas mixture to be measured. The first infrared optical radiation source is positioned such that the radiation emitted in a first wavelength range [λ₁, λ_{1′}] reaches the first multispectral detector through the interior space of the cuvette. A second radiation source is provided such that the radiation emitted in a second wavelength range [λ₂, λ_{2′}] reaches the second multispectral detector through the interior space of the cuvette. The wavelength ranges [λ₁, λ_{1′}] and [λ₂, λ_{2′}] are selected such that they will be different from one another.

The radiation emitted by the first infrared optical radiation source may advantageously extend in parallel to the radiation emitted by the second infrared optical radiation source and it travels over a path of equal length. The radiation emitted by the first infrared optical radiation source may extend in parallel to the radiation emitted by the second infrared optical radiation source and travels over a path of different length. The radiation emitted by the first infrared optical radiation source may also extend at right angles to the radiation emitted by the second infrared optical radiation source and travels over a path of different length.

According to another aspect of the invention, only one infrared optical radiation source is provided, directed through the interior space of the cuvette. The radiation emitted in the first wavelength range [λ₁, λ_{1′}] passes unhindered through a dichroic beam splitter and reaches the first multispectral detector. The radiation emitted in a second wavelength range [λ₂, λ_{2′}] is reflected by the dichroic beam splitter and reaches the second multispectral detector through the interior space of the cuvette. The wavelength ranges [λ₁, λ_{1′}] and [λ₂, λ_{2′}] are selected such that they will be different from one another.

The gas analyzer according to the present invention has at least one infrared optical radiation source and two multispectral detectors. Each multispectral detector is equipped with four infrared radiation detectors with infrared filters arranged in front of them. One example of a multispectral detector is described in DE 41 33 481 C2.

The four infrared filters belonging to the first multispectral detector transmit in different wavelength ranges: 4.25 μm, corresponding to the absorption wavelength of carbon dioxide;

3.98 μm, corresponding to the absorption wavelength of laughing gas; 3.7 μm as the reference wavelength, and also, e.g., in the wavelength range of 3.3 μm, corresponding to the absorption wavelength of methane, a foreign gas accumulating in a closed breathing circuit. The central wavelengths and the half-width values are selected for each of the four infrared filters such that the concentrations of carbon dioxide, laughing gas and optionally methane can be determined on the four measuring channels and a reference channel is also available.

Instead of determining the concentration of methane, it is also possible to determine the concentration of another foreign gas accumulating in a closed breathing circuit or of an anesthetic gas with the corresponding measuring channel. The transmission wavelength of the infrared filter belonging to this measuring channel must be adapted for this purpose to the absorption wavelength of the gas whose concentration is to be measured. The radiation reaching the first multispectral detector from a first infrared optical radiation source comprises at least the transmission wavelength ranges of the four infrared filters of the first multispectral detector.

If the first infrared optical radiation source emits radiation in the wavelength range [λ₁, λ_{1′}], where λ₁ and λ_{1′}, are numerical values for the wavelength of the radiation and [λ₁, λ_{1′}] is the interval located between λ₁ and λ_{1′}, the wavelengths 4.25 μm, 3.98 μm, 3.7 μm and 3.3 μm would have to be contained in the interval [λ₁, λ_{1′}]. This is given, e.g., if λ₁=3 μm and λ_{1′}=5 μm.

The four infrared filters belonging to the second multispectral detector transmit in the wavelength ranges of 8.605 μm, 8.386 μm, 8.192 μm and in a reference wavelength range of 10.488 μm. An algorithm for the identification and the concentration measurement of the gaseous anesthetics desflurane, enflurane, halothane, isoflurane, sevoflurane as well as laughing gas and carbon dioxide by means of this infrared filter configuration has already been known from DE 196 283 10 C2. The measurement and identification of the anesthetic gases which is performed by the second multispectral detector takes place more slowly than the measurement performed by the first multispectral detector and it therefore takes more time. The radiation reaching the second multispectral detector from a second infrared optical radiation source comprises at least the transmission wavelength ranges of the four infrared filters of the second multispectral detector. If the second infrared optical radiation source emits radiation in the wavelength range [λ₂, λ_{2′}], where λ₂, and λ_{2′} are numerical values for the wavelength of the radiation and [λ₂, λ_{2′}] is the interval between λ₂ and λ_{2′}, the wavelengths of 8.605 μm, 8.386 μm, 8.192 μm, and 10.488 μm must be contained in the interval of [λ₂, λ_{2′}]. This is given, e.g., if λ₂=8 μm and λhd 2′=11 μm.

To measure the gas concentrations resolved for individual breaths in a gas mixture, more rapid measurement of the gaseous anesthetic concentrations is necessary. The measuring channel with the infrared filter and the transmission wavelength range of 3.3 μm for the measurement of the methane concentration is replaced in this case in the first multispectral detector with an infrared filter with the transmission wavelength of 8.89 μm for measuring anesthetic gas concentrations. The half-width value of this infrared filter is about 300 nm, i.e., above the half-width value of the infrared filter of the second multispectral detector. This is about 130 nm. All anesthetic gases absorb in the central wavelength range of 8.89 μm, and there is only a slight cross sensitivity to laughing gas. The combination of an infrared filter in the first multispectral detector with a central wavelength of 8.89 μm and a half-width value of 300 nm with the infrared filters of the second multispectral detector provides additional parameters for the identification and the determination of the concentrations of the anesthetic gases and thus expedites the identification and the measurement of the anesthetic gases.

In another embodiment of the gas analyzer, only a single infrared optical radiation source is used, which emits radiation in the wavelength ranges [λ₁, λ_{1′}] and [λ₂, λ_{2′}]. By means of a dichroic beam splitter, the radiation in the wavelength range [λ₁, λ_{1′}] is sent to the first multispectral sensor and the radiation in the wavelength range [λ₂, λ_{2′}] is sent to the second multispectral sensor.

The laughing gas concentration measured with the first multispectral detector is used in the process according to the present invention to correct the anesthetic gas concentration measured with the second multispectral detector, because there is a cross sensitivity to laughing gas during the measurement of the anesthetic gas concentrations.

The anesthetic gas concentrations measured by the second multispectral detector are subsequently used to correct the laughing gas concentration measured with the first multispectral detector, because, conversely, there is also a cross sensitivity to the anesthetic gases during the measurement of the laughing gas concentration.

This correction of the measured values of both the first and second multispectral detectors is performed by means of an evaluating and control unit.

The calculation of gas concentrations by means of the correction of measured signals to compensate cross sensitivities, e.g., to laughing gas, is performed as follows:

The cross sensitivity to laughing gas is measured during the calibration of an infrared radiation detector as a function of the laughing gas concentration and stored in the form of concentration-dependent correction factors. If the infrared radiation detector is used, e.g., to measure the concentration of the anesthetic gas, the overall transmission measured by the corresponding infrared filter is obtained according to the Bouguer-Lambert-Beer law as a product of the transmission characteristic of pure halothane by the corresponding correction factor. Conversely, the transmission of the corresponding infrared filter, which transmission is characteristic of halothane alone, is obtained as a quotient of the measured overall transmission and the correction factor.

The identification and the concentration measurement of different gases in a gas mixture as well as the correction of a cross sensitivity to laughing gas is thus performed by the integration of two paths of rays in a cuvette. External interfering effects, such as changes in temperature, mechanical shocks or vibrations will thus always act on the entire gas analyzer.

Consequently, no compensation needs to take place between the two paths of rays. Further details of the present invention will be explained as an example on the basis of Figures, which show preferred embodiments of the infrared optical gas analyzer.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a schematic view showing an infrared optical gas analyzer with two paths of rays of equal length extending in parallel in a lateral cross section;

FIG. 2 is a schematic view showing an infrared optical gas analyzer with two paths of rays of different lengths extending at right angles to one another in a lateral cross section,

FIG. 3 is a schematic view showing an infrared optical gas analyzer with two paths of rays of different lengths extending in parallel in a lateral cross section, and

FIG. 4 is a schematic view showing an infrared optical gas analyzer with a split path of rays in a lateral cross section.

### DESCRIPTION OF THE PREFERRED EMBODIMENTS

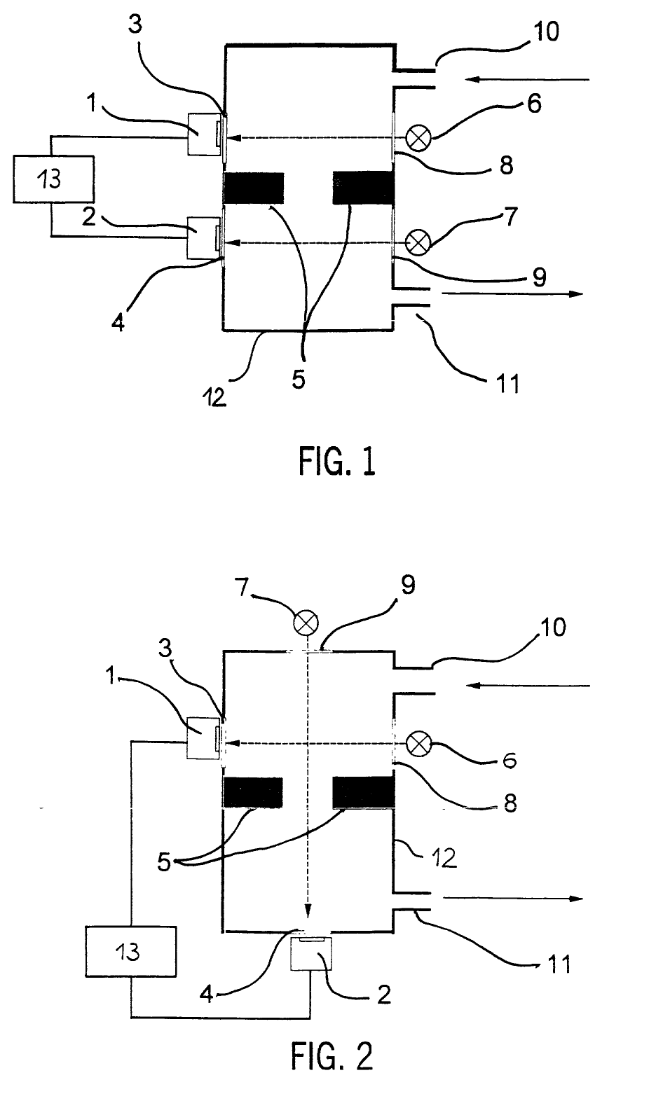

Referring to the drawings in particular, the infrared optical gas analyzer in FIG. 1 is characterized by two paths of rays of equal length of infrared optical light extending in parallel, which are integrated in a cuvette 12. The paths of rays are represented by the two horizontally extending arrows. Gas is admitted into the cuvette 12 via the gas inlet 10, represented by an arrow pointing into the cuvette 12 at the gas inlet 10. The measured gas leaves the cuvette 12 via the gas outlet 11. An arrow at the gas outlet 11 points out of the cuvette 12.

Two infrared optical radiation sources 6 and 7 as well as two multispectral detectors 1 and 2 are located outside the cuvette 12. Four infrared radiation detectors each with infrared filters arranged in front of them, which are not shown in FIG. 1, are arranged in the first multispectral detector 1 and in the second multispectral sensor 2. The radiation emitted by the first infrared optical radiation source 6 comprises at least the transmission wavelength ranges of the four infrared filters of the first multispectral detector 1, and the radiation emitted by the second infrared optical radiation source 7 comprises at least the transmission wavelength ranges of the four infrared filters of the second multispectral detector 2. The infrared radiation emitted by the first infrared optical radiation source 6 is passed through the interior space of the cuvette 12 through an entry window 8, which is transparent to infrared light, and an exit window 3, which is transparent to infrared light, after which it reaches the multispectral detector 1. The infrared filters have a defined transmission wavelength each, at which they are transparent to the arriving infrared radiation. The transmission wavelength of an infrared filter is identical to the absorption wavelength of the gas to be measured by the corresponding infrared detector. Thus, the multispectral detector 1 gas four different measuring channels. A ray-mixing system in the form of a pyramid system located in the first multispectral detector 1, which is not shown in FIG. 1, deflects the emitted infrared radiation proportionately to the four measuring channels.

The infrared radiation emitted by the second infrared optical radiation source 7 is likewise passed through the interior space of the cuvette 12 through an entry window 9, which is transparent to infrared light, and an exit window 4, which is transparent to infrared light, and it reaches the second multispectral detector 2, which has, based on its principle, the same design as the multispectral detector 1.

To prevent larger dead spaces, a pneumatic diaphragm 5 is arranged between the two paths of rays integrated in the cuvette 12. The radiation of the infrared optical radiation source 6, which is received by the first multispectral detector 1, and the radiation of the infrared optical radiation source 7, which is received by the second multispectral detector 2, are sent as signals to an evaluating and control unit 13.

FIG. 2 shows an infrared optical gas analyzer, in which two paths of rays of different length of infrared optical light, which are integrated in the cuvette 12, are directed at right angles to one another. The paths of rays are represented by a horizontal arrow and a vertical arrow, both arrows being drawn in broken lines. The gas is admitted into the cuvette 12 as described in the description of FIG. 1. Aside from the arrangement in space of the infrared optical radiation sources 6 and 7 as well as of the multispectral detectors 1 and 2, which is different from that in FIG. 1, the infrared optical gas analyzer shown in FIG. 2 is identical to that shown in FIG. 1 and operates according to the same principle. Due to the fact that the path length of the second ray path between the infrared optical radiation source 7 and the multispectral detector 2 is longer than the path length of the first ray path between the infrared optical radiation source 6 and the multispectral detector 1, a path length that is optimal for the concentration measurement and the identification of the gases can be provided for each of the two paths of rays independently from one another. The optimal path length is determined essentially by the concentration range of the gases to be measured, which concentration range is of interest, and the activation cross section of the gases, which is characteristic of a given gas at a given measuring wavelength and is an indicator of the absorption coefficient of the gas in question at a given concentration.

The determination of optimal path lengths will be explained based on the example of the gases carbon dioxide and halothane.

The concentration range that is of interest for carbon dioxide is about 3 vol. %, based on the expiratory carbon dioxide concentration of an anesthetized patient. The concentration range of halothane is, as can be expected, 1 vol. %. The flooding during the anesthesia of an average patient takes place at about this concentration. Halothane is still administered at a concentration of 0.8 vol. % during the anesthesia, after the flooding. Thus, 1 vol. % can be considered to be a relevant concentration range for halothane.

The activation cross sections of both gases are known: The activation cross section of carbon dioxide is 1.81 10⁻² (mm vol. %)⁻¹ and the activation cross section of halothane is 8.627 ·10⁻³ (mm vol. %)⁻¹.

The requirement that the absorption coefficient of the two gases should be the same despite different concentrations and activation cross sections leads to an optimal path length of 7 mm for carbon dioxide and to an optimal path length of 46 mm for halothane if the Bouguer-Lambert-Beer law is taken into account. Increasing or decreasing the path lengths while maintaining their ratio causes no changes in the agreeing absorption behavior of the two gases.

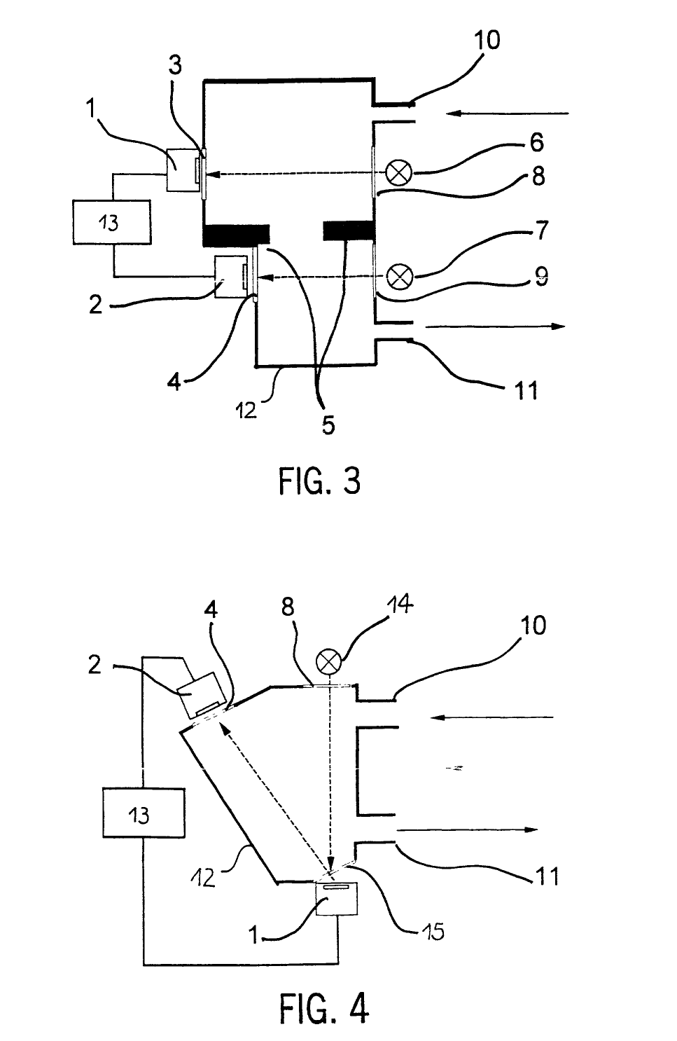

FIG. 3 shows an infrared optical gas analyzer in which two paths of rays of different length, which are integrated in the cuvette 12, extend in parallel to one another. The paths of rays are represented by the two horizontal arrows drawn in broken lines. The gas is admitted into the cuvette 12 as described in connection with FIG. 1. Aside from the fact hat the cuvette 12, which is wider above the pneumatic diaphragm 5 than below the pneumatic diaphragm 5, has a design different from that in FIG. 1, the infrared optical gas analyzer shown in FIG. 3 is identical to that in FIG. 1. The different path lengths of the two paths of rays of the infrared optical gas analyzer in FIG. 3 become advantageously noticeable in the same manner as the different path lengths of the two paths of rays of the infrared optical gas analyzer in FIG. 2, i.e., optimal path lengths can be provided for both paths of rays independently from one another.

Contrary to the infrared optical gas analyzers shown in FIGS. 1 through 3, the infrared optical gas analyzer in FIG. 4 has only one ray path. The ray path is represented by the two arrows drawn in broken lines. The gas is admitted into the cuvette 12 as described in connection with FIG. 1. An infrared optical radiation source 14 is located outside the cuvette 12. The infrared radiation emitted by the infrared optical radiation source 14 is passed through the interior space of the cuvette 12 partially through an entry window 8, which is transparent to infrared light, and a dichroic beam splitter 15 and it reaches the multispectral detector 1 from there. The part of the infrared radiation that is not passed through the dichroic beam splitter 15 is reflected at the dichroic beam splitter 15 and passes from there through the interior space of the cuvette 12 through the exit window 4, which is transparent to infrared light, to reach the second multispectral detector 2. The two multispectral detectors 1 and 2 have the same design as the multispectral detectors 1 and 2 in FIG. 1.

Since the radiation from the infrared optical radiation source 14 reaches both the first multispectral detector 1 and the second multispectral detector 2 after the radiation was partially reflected at the dichroic beam splitter 15, the infrared optical radiation source 14 contains at least the transmission wavelength ranges of the four infrared filters of the first multispectral detector 1 and of the four infrared filters of the second multispectral detector 2. The radiation emitted in the first wavelength range [λ₁, λ_{1′}] passes unhindered through the dichroic beam splitter 15 and reaches the first multispectral detector 1. The radiation emitted in a second wavelength range [λ₂, λ_{2′}] is reflected by the dichroic beam splitter 15 and reaches the second multispectral detector 2 through the interior space of the cuvette 12. The wavelength ranges [λ₁, λ_{1′}] and [λ₂, λ_{2′}] are selected such that they will be different from one another.

The radiation of the infrared optical radiation source 14, which is received by the first multispectral detector 1, and the radiation of the infrared optical radiation source 14, which is received by the second multispectral detector 2 by reflection at the dichroic beam splitter 15, are sent as signals to an evaluating and control unit 13.

While specific embodiments of the invention have been shown and described in detail to illustrate the application of the principles of the invention, it will be understood that the invention may be embodied otherwise without departing from such principles.

What is claimed is:

1. An infrared optical gas analyzer, comprising:
a cuvette containing the gas mixture to be measured;
a first multispectral detector;
a first infrared optical radiation source positioned such that the radiation emitted in a first wavelength range reaches the first multispectral detector through the interior space of the cuvette;
a second multispectral detector;
a second radiation source provided such that the radiation emitted in a second wavelength range reaches the second multispectral detector through the interior space of the cuvette, said first wavelength range and said second wavelength range being selected such that they will be different from one another.

2. An infrared optical gas analyzer in accordance with claim 1, wherein the radiation emitted by the first infrared optical radiation source extends in parallel to the radiation emitted by the second infrared optical radiation source and it travels over a path of equal length.

3. An infrared optical gas analyzer in accordance with claim 1, wherein the radiation emitted by the first infrared optical radiation source extends in parallel to the radiation emitted by the second infrared optical radiation source and travels over a path of different length.

4. An infrared optical gas analyzer in accordance with claim 1, wherein the radiation emitted by the first infrared optical radiation source extends at right angles to the radiation emitted by the second infrared optical radiation source and travels over a path of different length.

5. An infrared optical gas analyzer, comprising:
an infrared optical radiation source arrangement;
a first multispectral detector;
a second multispectral detector;
a cuvette containing the gas mixture to be measured, said infrared optical radiation source being positioned such that the radiation emitted in a first wavelength range reaches the first multispectral detector through the interior space of the cuvette and radiation emitted in a second wavelength range reaches the second multispectral detector through the interior space of the cuvette, said first wavelength range and said second wavelength range being selected such that they will be different from one another.

6. An infrared optical gas analyzer in accordance with claim 5, wherein said infrared optical radiation source arrangement includes a dichroic beam splitter wherein radiation emitted in the first wavelength range passes unhindered through said dichroic beam splitter and reaches the first multispectral detector and the radiation emitted in the second wavelength range is reflected by the dichroic beam splitter and reaches the second multispectral detector through the interior space of the cuvette.

7. An infrared optical gas analyzer in accordance with claim 5, wherein said infrared optical radiation source arrangement comprises a first infrared optical radiation source positioned such that the radiation emitted in the first wavelength range reaches the first multispectral detector through the interior space of the cuvette and second radiation source provided such that the radiation emitted in the second wavelength range reaches the second multispectral detector through the interior space of the cuvette.

8. An infrared optical gas analyzer in accordance with claim 7, wherein the radiation emitted by the first infrared optical radiation source extends in parallel to the radiation emitted by the second infrared optical radiation source and it travels over a path of equal length.

9. An infrared optical gas analyzer in accordance with claim 7, wherein the radiation emitted by the first infrared optical radiation source extends in parallel to the radiation emitted by the second infrared optical radiation source and travels over a path of different length.

10. An infrared optical gas analyzer in accordance with claim 7, wherein the radiation emitted by the first infrared optical radiation source extends at right angles to the radiation emitted by the second infrared optical radiation source and travels over a path of different length.

11. A process for determining gas concentrations with an infrared optical gas analyzer, the process comprising the steps of:
providing an infrared optical radiation source;
providing a first multispectral detector;
providing a second multispectral detector;
providing a cuvette containing the gas mixture to be measured;
positioning the optical radiation source such that the radiation emitted in a first wavelength range reaches the first multispectral detector through the interior space of the cuvette and radiation emitted in a second wavelength range reaches the second multispectral detector through the interior space of the cuvette;
selecting said first wavelength range and said second wavelength range such that they will be different from one another;
sending the radiation received by the first multispectral detector in the first wavelength range and sending the radiation received by the second multispectral detector in the second wavelength range as signals to an evaluating and control unit; and
calculating at the evaluating and control unit values for the concentrations of a first group of gases contained in the gas mixture from the signals of the radiation in the first wavelength range, which are received by the first multispectral detector;
calculating at the evaluating and control unit values for the concentrations of a second group of gases contained in the gas mixture from the signals of the radiation in the second wavelength range, which are received by the second multispectral detector.

12. A process in accordance with claim 11, wherein the signals of the radiation in the first wavelength range are used by the evaluating and control unit for the correction of the signals of the radiation in the first wavelength range in order to compensate cross sensitivities of the multispectral detector to the first group of gases contained in the gas mixture in the calculation of the concentrations of the second group of gases contained in the gas mixture.

13. A process in accordance with claim 11, further comprising the step of:
using the signals of the radiation in the second wavelength range by the evaluating and control unit for the correction of the radiation in the wavelength range in order to compensate the cross sensitivities of the multispectral detector to the second group of gases contained in the gas mixture in the calculation of the concentrations of the first group of gases contained in the gas mixture.
